(19) United States
(12) Patent Application Publication
(10) Pub. No.: US 2026/0236980 A1
(43) Pub. Date: Aug. 13, 2026

(54) AI-AUGMENTED SALES AND DISTRIBUTION OF LIVE EVENT MEDIA

(71) Applicant: Rodney Thomas YANCY, Tulsa, OK (US)

(72) Inventor: Rodney Thomas YANCY, Tulsa, OK (US)

(21) Appl. No.: 19/430,831

(22) Filed: Dec. 23, 2025

Related U.S. Application Data
(60) Provisional application No. 63/757,554, filed on Feb. 12, 2025.

(51) Int. Cl. G06Q 30/0601

(52) U.S. Cl. CPC G06Q 30/0641; G06Q 30/0633

(57) ABSTRACT

Live event media generation can include performing multiple steps and systems for their performance. These steps may include creating an event-specific landing page, where the event specific landing page is created by a member of a first user class. These steps can further include limiting access to the event-specific landing page to a second user class. These steps can also include receiving, via the landing page, event-specific media from members of the second user class. The steps can further include obtaining a master media recording of the event. The steps can also include combining the event specific media and master media recording into a resultant media. The resultant media can include at least one of a generated audio recording of the event, a generated video of the event, and combinations of the same.

### CROSS-REFERENCE TO RELATED APPLICATIONS

This application claims priority to and the benefit of the filing date of provisional U.S. Patent Application No. 63/757,554, entitled “System and Method for Marketing, Pre-release and Post-release Sales, Recording, AI-Based Mixing, and Digital Distribution of Live Music Performances” and filed on Feb. 12, 2025, the entire contents of which are hereby expressly incorporated herein by reference.

### TECHNICAL FIELD

Implementations of the present disclosure relate to systems and methods for sales and distribution, and more particularly to systems and methods for marketing, pre-release, and post-release sales, recording, AI-based mixing, and digital distribution of live music performances.

### BACKGROUND

Despite the proliferation of media-sharing platforms and event management tools, current digital solutions for capturing and distributing event experiences are fragmented and limited. Existing systems primarily allow either professional recordings or casual user uploads, but rarely integrate both in a structured, cohesive manner. As a result, the media products generated often lack authenticity, fail to reflect the diverse perspectives of attendees, and do not provide organizers with sufficient control over distribution or monetization. Additionally, conventional platforms lack robust verification mechanisms, making it difficult to ensure that media originates from genuine participants physically present at the event.

### SUMMARY

In accord with one general aspect, described herein is a system having a processor and a memory in communication with the processor, where the memory includes executable instruction that, when executed by the processor, cause the system to perform multiple functions. These functions may include creating an event-specific landing page, where the event specific landing page is created by a member of a first user class. These functions can further include limiting access to the event-specific landing page to a second user class. These functions can also include receiving, via the landing page, event-specific media from members of the second user class. The event specific media can include at least one of digital photographs of the event, audio recordings of the event, videos of the event, and combinations of the same. The functions can further include obtaining a master media recording of the event. The master media recording can include at least one of audio recordings of the event, videos of the event, and combinations of the same. The functions can also include combining the event specific media and master media recording into a resultant media. The resultant media can include at least one of a generated audio recording of the event, a generated video of the event, and combinations of the same.

In accord with another general aspect the method described herein may involve multiple steps. These steps may include creating an event-specific landing page, where the event specific landing page is created by a member of a first user class. These steps can further include limiting access to the event-specific landing page to a second user class. These steps can also include receiving, via the landing page, event-specific media from members of the second user class. The event specific media can include at least one of digital photographs of the event, audio recordings of the event, videos of the event, and combinations of the same. The steps can further include obtaining a master media recording of the event. The master media recording can include at least one of audio recordings of the event, videos of the event, and combinations of the same. The steps can also include combining the event specific media and master media recording into a resultant media. The resultant media can include at least one of a generated audio recording of the event, a generated video of the event, and combinations of the same.

In accord with yet another general aspect, the instant disclosure describes a non-transitory computer readable medium on which are stored instructions that when executed cause a programmable device to perform multiple functions. These functions may include creating an event-specific landing page, where the event specific landing page is created by a member of a first user class. These functions can further include limiting access to the event-specific landing page to a second user class. These functions can also include receiving, via the landing page, event-specific media from members of the second user class. The event specific media can include at least one of digital photographs of the event, audio recordings of the event, videos of the event, and combinations of the same. The functions can further include obtaining a master media recording of the event. The master media recording can include at least one of audio recordings of the event, videos of the event, and combinations of the same. The functions can also include combining the event specific media and master media recording into a resultant media. The resultant media can include at least one of a generated audio recording of the event, a generated video of the event, and combinations of the same.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A is a flow diagram illustrating an example method for sales and generation of a resultant media.

FIG. 1B is an example interface for creation of the event-specific landing page in accordance with the method of FIG. 1A.

FIG. 1C is an example view of the landing page without user authentication in accordance with the method of FIG. 1A.

FIG. 1D is an example view of the landing page based on user authentication in accordance with the method of FIG. 1A.

FIG. 1E is an example interface for receiving event-specific media in accordance with the method of FIG. 1A.

FIG. 1F is an example interface for receiving master media in accordance with the method of FIG. 1A.

FIG. 2A is another flow diagram illustrating an example method for sales and generation of the resultant media as in FIG. 1A that further includes distribution of the resultant media.

FIG. 2B is a flow diagram illustrating an example method of tokenization shown in FIG. 2A.

FIG. 2C is an example interface for receiving distribution limits according to the method of FIG. 2A.

FIG. 2D is an example interface for downloading the resultant media in accordance with the method of FIG. 2A.

FIG. 3A is another flow diagram illustrating an example method for sales and generation of the resultant media as in FIG. 1A that further includes that includes verifying a physical presence.

FIG. 3B is an example interface for verification of physical presence in accordance with the method of FIG. 3A.

FIG. 4 depicts an example architecture in which the methods of FIGS. 1-3 of the present embodiments may operate.

FIG. 5 is a block diagram showing an example system of the architecture of FIG. 4 along with its corresponding subsystems.

FIG. 6A is an example data flow of the present embodiments organized into pre-event, event, and post-event phases.

FIG. 6B is an example interface for tracking pre-sale engagement in accordance with the data flow of FIG. 6A.

FIG. 7 is a block diagram showing an example software architecture, various portions of which may be used in conjunction with various hardware architectures herein described, which may implement any of the described features.

FIG. 8 is a block diagram showing components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

### Technical Problem

Despite advancements in digital media platforms, existing systems for capturing and distributing event experiences remain fragmented, inflexible, and limited in scope. Some solutions either rely on professional recordings that lack attendee perspective, or crowd-sourced uploads that lack quality and cohesion. Neither approach, in isolation, provides a comprehensive representation of the event. This can result in media products that fail to capture the authentic atmosphere while simultaneously meeting the quality standards expected by organizers and consumers. Moreover, some platforms lack the infrastructure to enforce access control or verify that uploaded content originates from genuine attendees physically present at the event. Such shortcomings expose organizers to risks of irrelevant or fraudulent submissions, while undermining the exclusivity and value of the final product. Distribution can present an additional challenge: once generated, event media is often disseminated in uncontrolled ways, with little regard for licensing, monetization, or audience segmentation. Tokenization and rights enforcement are typically absent, making piracy and unauthorized redistribution common. As a result, event organizers are deprived of essential tools to govern how media is shared, sold, or promoted. Taken together, these challenges highlight a significant technological gap in digital media workflows, where authenticity, quality, and control must be integrated into a unified system for event-based media capture and distribution.

### Technical Solution

The present embodiments introduce a unified framework for digital media capture, processing, and controlled distribution in event-based contexts. This can include the creation of event-specific landing pages, designed and deployed by organizers (a first user class), which can act as secure and branded digital hubs. These landing pages enable controlled access, limiting participation to verified attendees through authentication mechanisms such as ticket-linked credentials, geofencing, or QR code validation. Based on authentications, members of a separate (second) user class can contribute event-specific media, including photographs, audio, and video, which can be time-stamped, tagged, and stored securely. In parallel, professional-grade master media recordings are obtained from official sources, ensuring high-fidelity coverage. Both streams of content can be then ingested into a media generation subsystem, where advanced processing tools—including AI-driven synchronization, noise reduction, and multi-perspective stitching—can combine the user-generated material with the master recording. The result can be a polished yet authentic composite media product. To safeguard and manage distribution, the embodiments can incorporate tokenization and rights enforcement, embedding organizer-defined limits into the resultant media. This provides that downloads, streaming, and redistribution comply with predefined business models, whether free, premium, or geographically restricted. By integrating content capture, verification, processing, and distribution into a single pipeline, the disclosed embodiments can resolve fragmentation, enhance authenticity, and empower organizers to retain meaningful control over event media lifecycles.

### Advantages of the Technical Solution

The disclosed embodiments can provide several advantages over existing media platforms and event management tools. First, they can offer a balanced integration of professional and attendee perspectives, providing that resultant media combines high-quality production with authentic crowd-sourced contributions. This dual input creates richer, more immersive content that appeals to both organizers and consumers. Second, the incorporation of access controls and presence verification ensures authenticity, providing that only verified attendees can contribute media. This not only prevents irrelevant or fraudulent submissions but also enhances consumer trust in the integrity of the final product. Third, the implementations can provide organizers with customizable governance through distribution limits and tokenization, allowing them to control who accesses the media, under what conditions, and in what form. These features enable innovative monetization strategies, from pre-sale packages to tiered downloads, while also protecting intellectual property through embedded rights management. Additionally, the use of AI-driven processing provides that the final product is polished, synchronized, and professional, without losing the spontaneity of participant contributions. Further, the centralized event-specific landing page streamlines user engagement by consolidating all media collection, interaction, and distribution within a single, branded environment. By incorporating access controls, physical presence verification, tokenization, and customizable distribution limits, the disclosed embodiments bridge the gap between professional production quality and authentic crowd-sourced contributions. This addresses both a technological deficiency in media integration and an unmet need among organizers, participants, and consumers for secure, authentic, and customizable event-based media products. Taken together, these advantages provide that the embodiments are a robust, scalable, and secure solution that addresses unmet technological and experiential needs in digital event media.

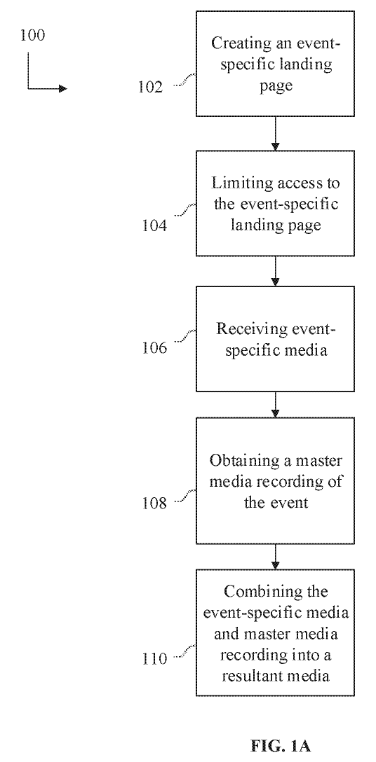

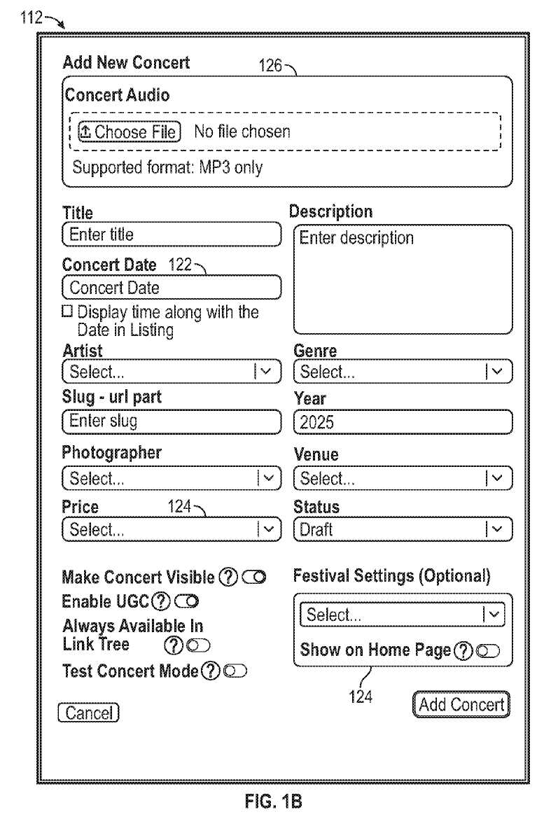

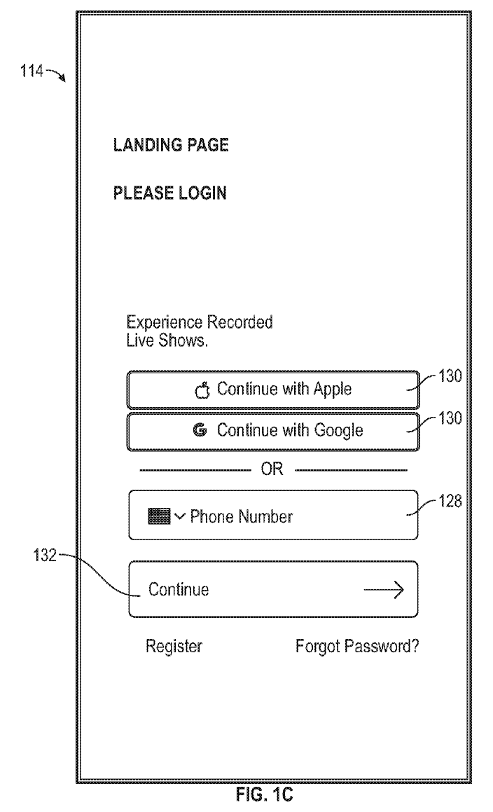

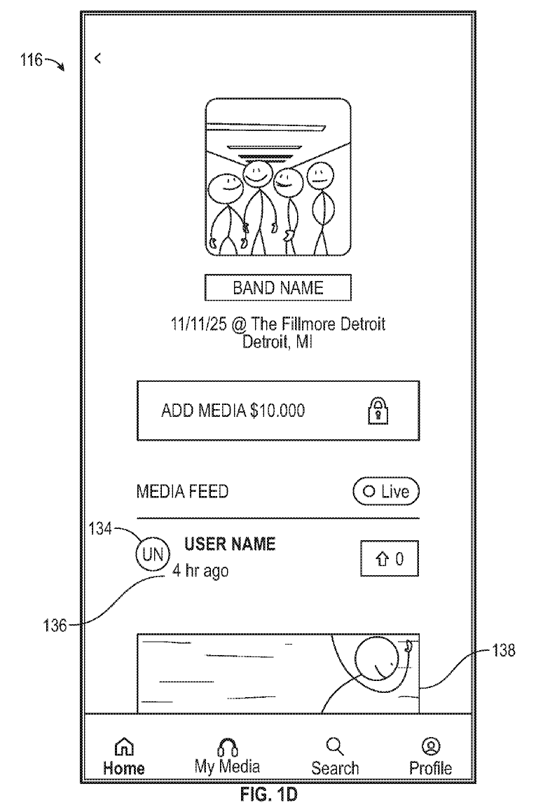

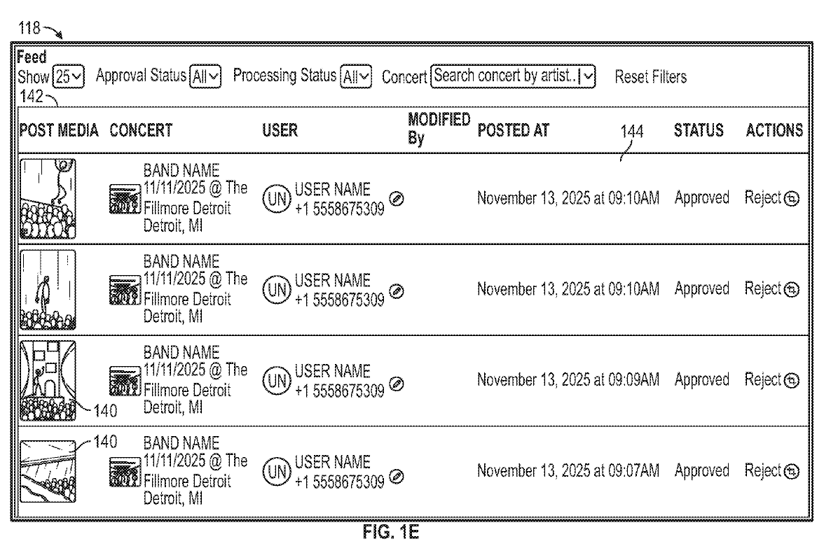

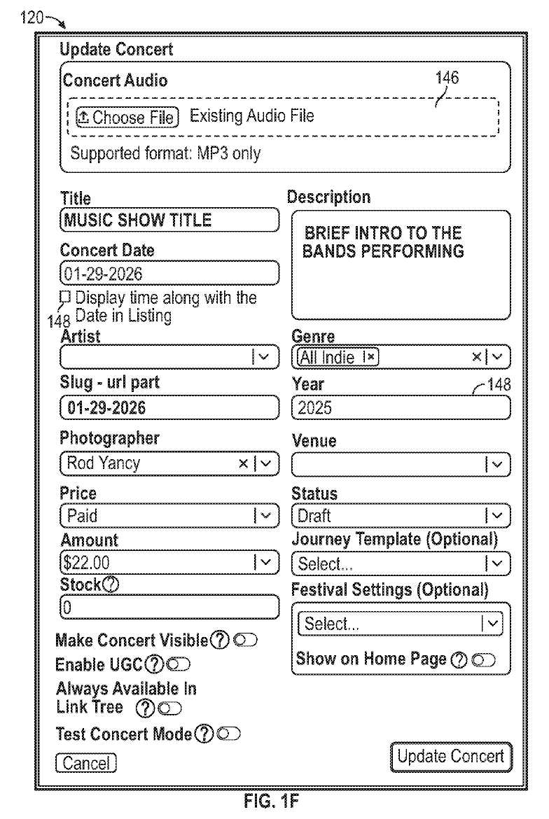

FIG. 1A is a flow diagram illustrating an example method 100 for generation of a resultant media. The resultant media can include an official release of generated audio recording of the event, a generated video of the event, and combinations of the same. The method 100 can include creating an event-specific landing page (Step 102). The creation of an event-specific landing page provides a central hub that can serve for capturing, curating, and distributing media related to the event. This landing page is typically generated by a member of a first user class, such as, for example, an event organizer, promoter, a band, or an authorized administrator. Its structure can be tailored to the details of the event, including metadata such as the event title, date, location, performer or participant information, and associated branding elements. The landing page can function as a digital environment, where participants, specifically designated members of a second user class, can later interact by contributing media or accessing content. Its design may support multimedia upload features, real-time content integration, and ordering or distribution options for resultant media. The landing page may be hosted on a secure server, integrated with back-end databases, and configured for both web and mobile device access. It can incorporate application programming interfaces for social sharing, payment gateways, or media processing modules. The landing page is not a generic site but one that is created in direct relation to a specific event, thereby contextualizing user contributions and providing a framework for later aggregation with a master recording. By establishing a controlled and centralized environment, the system provides a seamless workflow where event-specific media can be captured, processed, and ultimately distributed in a cohesive manner.

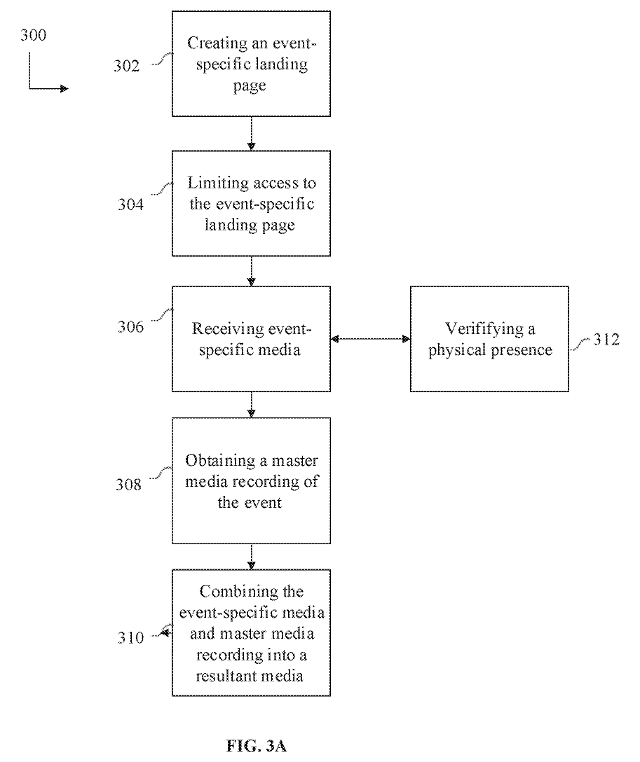

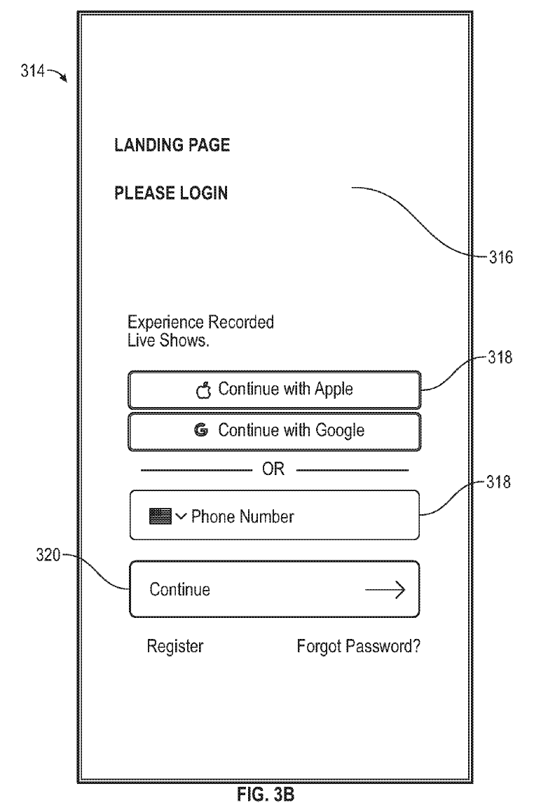

The method 100 can include limiting access to the event-specific landing page (Step 104). Based on establishment of the landing page, the method can enforce access restrictions to maintain security and relevance. Access is typically limited to a second user class, which may consist of event attendees, performers, crew members, or other verified participants. Restricting access provides that only individuals with a legitimate connection to the event can upload or interact with event-specific media. Verification mechanisms may include the use of login credentials, QR code tickets, tokenized passes, or geofencing tied to the physical location of the event, which are discussed further below with regard to FIG. 3A A. In some embodiments, the method can require proof of physical presence, such as GPS signals or Bluetooth beacons before granting access to the landing page or to some features of it. This limitation can provide multiple benefits: it safeguards against irrelevant or unauthorized submissions, preserves the integrity of the media archive, and enhances privacy and exclusivity for both the event organizers and participants. These access controls can be implemented through authentication servers, encrypted connections, and layered permissions tied to user classes. The access limitation also can enable differentiation between content contributors and content administrators. For example, the first user class (organizers) may manage media approval and eventual distribution, while the second user class (attendees) can be restricted to content upload and limited interactions. By confining contributions to verified participants, the system can provide that the resultant media collection is authentic, event-specific, and representative of the shared experiences of those actually present.

The method 100 can include receiving event-specific media (Step 106). Based on access controls, the landing page can be an interface for collecting media from attendees or participants. Members of the second user class may upload digital photographs, audio recordings, video clips, or combinations thereof. This user-generated media provides a diverse record of the event, capturing perspectives and moments that may not be present in the official master recording. The method can be designed to handle multiple media formats and resolutions, providing upload functionality that may include drag-and-drop features, mobile camera integration, or direct API connections for social media platforms. On the back end, uploaded content may be time-stamped, tagged with user identifiers, and associated with metadata such as location or device information. Storage can occur within a secure database or cloud environment optimized for media handling, where redundancy and versioning protect against data loss. Depending on implementation, the method may include filters or AI-driven preprocessing modules to verify quality, detect inappropriate material, or sort files by type. Collecting user-generated media can enrich the dataset by blending professional and crowd-sourced content. This can provide a more dynamic and authentic reconstruction of the event, setting the stage for its integration with the master media recording in subsequent steps.

The method 100 can include obtaining a master media recording of the event (Step 108). Parallel to the collection of user-generated content, the method can obtain a master media recording of the event. This master recording may consist of high-quality professional audio, video, or synchronized multimedia captured by official event equipment. The master recording can serve as the authoritative reference against which participant contributions can be aligned. Depending on the event type, this could include a concert’s full soundboard audio, multi-camera stage video, or official broadcast feed. The master recording may be obtained directly from production teams, audio engineers, or automated high-fidelity capture devices installed at the venue. Metadata such as timestamps, camera identifiers, and track information may accompany the recording to facilitate synchronization. The system may also ingest multiple master feeds—for example, separate audio and video streams—that are later merged with user-provided material. Quality assurance checks can provide that the master file meets technical specifications and remains free from corruption. The presence of a master recording can provide structural coherence for the eventual merging process. It can provide that the resultant media retains professional clarity while being enriched with diverse audience perspectives. By establishing this official baseline, the method can maintain a balance between polished production quality and authentic participant contributions, enabling the generation of a hybrid product that is both technically robust and emotionally engaging.

The method 100 can include combining the event-specific media and master media recording (Step 110). This combination can integrate the crowd-sourced media collected through the landing page with the professionally obtained master recording. This combination produces the resultant media, which may take the form of a generated audio recording, video compilation, or a synchronized multimedia presentation. The integration process may leverage advanced computational methods, including neural networks, vision-language models, or other AI-driven modules capable of aligning, enhancing, and blending disparate media inputs. For instance, uploaded video clips can be synchronized with the master audio track to provide multi-angle coverage, while photographs may be sequenced into time-aligned slideshows enriched with background sound. Technical workflows may involve preprocessing for resolution matching, noise reduction, and color correction, followed by algorithmic stitching or overlay. The resultant media can also incorporate tagging and indexing features to allow users to navigate between perspectives or highlights. From a governance standpoint, a member of the first user class may review and approve the final product prior to distribution. Once approved, the media can be distributed digitally, offered for download, or monetized through ordering systems embedded in the landing page. Thereby, the method 100 can transform fragmented, heterogeneous inputs into a cohesive, polished artifact that captures both the professional fidelity of the master recording and the authenticity of participant contributions, thereby delivering a unique, value-added product.

In an exemplary embodiment, the event specific media and master media can be combined to form the resultant media via a neural network. In this embodiment, a neural network serves as the computational core that combines the event-specific media and the master media recording into the resultant media. This can begin by encoding each media input, which can include digital photographs of the event, audio recordings of the event, videos of the event, and combinations thereof in the form of images, video frames, or audio segments, into a normalized prompt object. The normalized prompt object can be a structured multimodal representation that aligns different types of content into a common latent space. Each element of the prompt object can be represented as a vector embedding that can include semantic, spatial, and temporal relationships. For example, visual features such as lighting, angle, or performer position can be encoded into high-dimensional vectors, while audio waveforms are decomposed into frequency and temporal tensors that can represent harmonic and rhythmic structure.

The neural network can then perform cross-modal alignment, in which embeddings from the event-specific uploads can be correlated with embeddings from the master media. Utilizing attention mechanisms, the model can identify regions or time segments of overlap by weighting vectors according to their semantic and temporal relevance. A normalized tensor field can be constructed that fuses these embeddings, forming a coherent, context-aligned latent representation of the event across perspectives.

A fusion layer can translate the combined latent tensors back into a media-space through at least one decoding network, here called a decoder for simplicity. The decoder can reconstruct synchronized audio-visual frames, guided by learned positional and temporal constraints embedded during training. By continuously and iteratively optimizing the alignment loss between source embeddings and reconstructed output, the decoder provides that the resultant media maintains narrative coherence and audiovisual fidelity. Based on the fusion, the neural network can generate the resultant media as an output tensor sequence, which can then be normalized and formatted for distribution. Because media inputs were first encoded into structured, vectorized representations, the system can preserve both the authenticity of attendee perspectives and the quality of the professional recording. The resultant media object is not a simple overlay, but a data-fused reconstruction derived from encoded embeddings, yielding a unified, contextually aware artifact that can reflect the collective experience of the event while adhering to organizer-defined fidelity and distribution parameters.

In another embodiment, the event specific media and master media can be combined to form the resultant media via a vision language model (VLM). In this embodiment, a VLM serves as the multimodal integrator that combines the event-specific media contributed by attendees with the master media recording captured by professionals, generating a cohesive resultant media that reflects both the authenticity of participant perspectives and the fidelity of professional production. This can begin with the encoding of all inputs, which can include videos, images, audio spectrograms, and textual metadata, into a normalized prompt object, which can serve as a unified schema for downstream multimodal reasoning. Each component of this prompt object can be represented as a structured collection of vectors, embeddings, and tensors that preserve the semantic, spatial, and temporal relationships inherent in the raw data.

Visual inputs such as photographs and video frames can be encoded into high-dimensional visual embeddings, thereby capturing objects, faces, lighting conditions, and spatial orientation. In parallel, audio signals from the master recording can be converted into spectrogram tensors that represent frequency–time distributions. Metadata, such as timestamps or user captions, can be processed through a language encoder to produce semantic text embeddings, allowing the model to contextualize what each visual or auditory input represents within the narrative of the event. The VLM can then align all these modalities within a shared embedding space, using cross-attention layers to correlate visual and textual semantics across both the user-generated and master data streams. Once encoded, the system can perform prompt conditioning, wherein the normalized prompt object serves as a multimodal query to the model. For example, the prompt can encode desired relationships such as “align crowd perspective video with master audio” or “synchronize stage footage with attendee uploads at corresponding timestamps.” Attention-weighted fusion layers can evaluate the similarity and complementarity of embeddings between the event-specific and master media. The model can dynamically adjust the vector weights for contextual coherence, thereby amplifying relevant attendee perspectives that combine narrative moments with a preserved continuity and acoustic clarity of the master media.

An intermediate fusion state can be represented as a latent tensor map, which can be an encoded multimodal manifold that captures correlated representations of sound, movement, and scene context across a plurality of viewpoints. The VLM can include a decoder that interprets this tensor map to reconstruct synchronized frames and audio segments that form the resultant media. As the embeddings from both modalities coexist in a shared latent schema, the output can preserve the professional-grade timing, tone, and clarity of the master media while integrating user-provided spontaneity and perspective of the event-specific media.

Thereby, the VLM functions as a semantic alignment and synthesis engine, translating multiple sensory streams into a single coherent artifact. Each layer, which can include encoding, fusion, and decoding, can operate over high-dimensional tensors guided by semantic relationships encoded in the prompt object. The final resultant media is then rendered into human-perceptible form, maintaining the temporal synchronization and aesthetic integrity of the master recording while embedding the emotional and experiential nuances contributed by verified attendees.

FIG. 1B is an example interface 112 for creation of the event-specific landing page in accordance with the method of FIG. 1A. This interface 112 can enable a member of the first user class to create the event-specific landing page through an intuitive, structured configuration environment. The interface 112 can present a series of interactive fields, panels, and selectable modules that collectively define the metadata, branding, access parameters, and functional components of the landing page. Through this interface 112, the organizer can enter event details 122 such as the event name, date, location, and descriptive text, as well as upload or incorporate graphics, logos, or promotional imagery that visually characterize the event. The interface 112 can further include selectable elements for configuring upload permissions, user-class restrictions, and distribution settings 124, thereby allowing the first user class to embed operational and access logic directly into the landing page at creation time. In some implementations, the interface 112 can present options for enabling media-upload modules 126, preview windows, order-form integration, or download portals that will later support event-specific media submission and resultant-media distribution. The interface 112 thereby functions not merely as a design tool but as a control platform through which the organizer defines the structural and functional aspects of the event-specific digital environment. By centralizing these configuration tasks into a single interactive interface 112, landing-page creation can be consistent, secure, and seamlessly integrated with the later media-collection and media-generation workflows.

FIG. 1C is an example view of the landing page 114 without user authentication in accordance with the method of FIG. 1A. In this state, the landing page functions primarily as a public-facing informational interface. In some implementations, the landing page 114 can provide high-level event details while deferring access to privileged or interactive features. In some implementations, the landing page 114 can display the event name, location, date, promotional text, and any associated branding or imagery uploaded by the first user class during the page-creation phase. However, functional components such as media-upload modules, ordering controls, and distribution portals can remain inaccessible until proper authentication occurs. In some implementations, the landing page 114 can request login information 128 and provide a plurality of login credential provision methods, which can include third party mechanisms 130. To guide the user toward login, the landing page 114 can incorporate clear interface elements such as a “Sign In,” “Verify Attendance,” or “Access Event Portal” button 132. When selected, these elements can initiate the authentication workflow, which may include credential entry, QR-code scanning, token-pass validation, or geofencing confirmation depending on the verification modality selected by the organizer. Until login occurs, the landing page may also display limited preview components—such as placeholders for user-generated media or banners indicating that additional features will become available upon verification.

FIG. 1D is an example view of the landing page 116 based on user authentication in accordance with the method of FIG. 1A. Based on such authentication, the landing page 116 can transition from an informational interface and login portal into a fully interactive environment tailored to the user’s role within the second user class. Functional components that were previously restricted, such as media-upload panels, submission forms, or contribution dashboards 134, can become active. Through these components, authenticated users can upload event-specific media 138, including photographs, audio recordings, and video clips, which can be subsequently encoded, stored, and incorporated into the resultant-media pipeline. The authenticated version of the landing page 116 can also present personalized elements 136, such as the user’s name, validation timestamp, or confirmation of verified attendance. Additional modules can include upload guidelines, quality-control prompts, or timelines indicating when resultant media will be available. Depending on the organizer’s configuration, the logged-in landing page 116 may further provide purchasing options, pre-order features, or early-release content tied to distribution and tokenization settings.

FIG. 1E is an example interface 118 for receiving event-specific media in accordance with the method of FIG. 1A. This interface 118 can become accessible once the user has logged in or verified physical presence through one of the verification modalities described herein. The interface 118 can provide a structured environment through which users may upload media 140 such as digital photographs, short video clips, audio snippets, or combinations thereof captured during the live event. In some implementations, the interface 118 can include drag-and-drop upload zones 142, file-selection controls, camera-capture buttons for real-time submission, and status indicators 144 such as upload progress bars or confirmation prompts. Users can also be presented with metadata entry fields, for example, tagging the location within the venue, identifying performers, or providing contextual descriptions, which can be encoded into embeddings for synchronization and media-generation workflows. In some implementations, quality-assurance features may also be integrated, such as automatic file-type validation, resolution checks, or prompts encouraging users to select clearer or more relevant submissions. In some implementations, the interface 118 can display submission guidelines, privacy notices, or reminders that only verified attendees may contribute content.

FIG. 1F is an example interface 12 for receiving master media in accordance with the method of FIG. 1A. Through the interface 120, a member of the first user class, typically the event organizer, production team, or authorized media partner, can upload 146 or otherwise supply the master media recording of the event. This interface 120 can be designed to accommodate high-quality audiovisual content, such as multi-camera video feeds, full-length audio recordings, or synchronized stage-capture files. The interface 120 can provide secure upload mechanisms capable of handling large media files, including high-resolution video and multi-track audio. It can include file-selection dialogs, bulk-upload controls, progress indicators, and checksum-based integrity validation to provide that the master recording is complete and uncorrupted. In some embodiments, the interface 120 can also support direct ingestion from external recording systems or cloud-based storage environments, thereby providing integration with professional production equipment. Metadata fields 148 within the interface 120 can allow the organizer to annotate the master media with timestamps, track identifiers, camera designations, or performance notes. These annotations can be later encoded into embeddings used during the synchronization stage, improving alignment with event-specific media contributed by attendees.

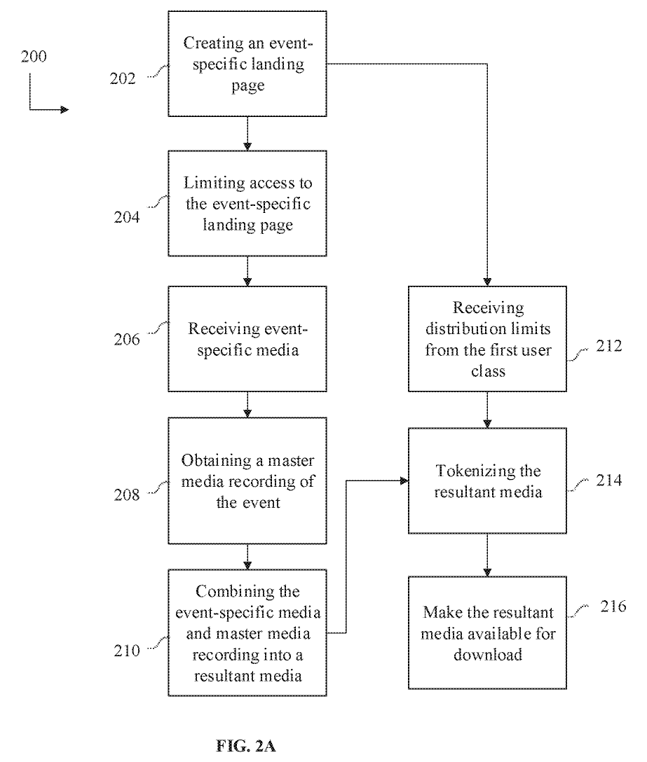

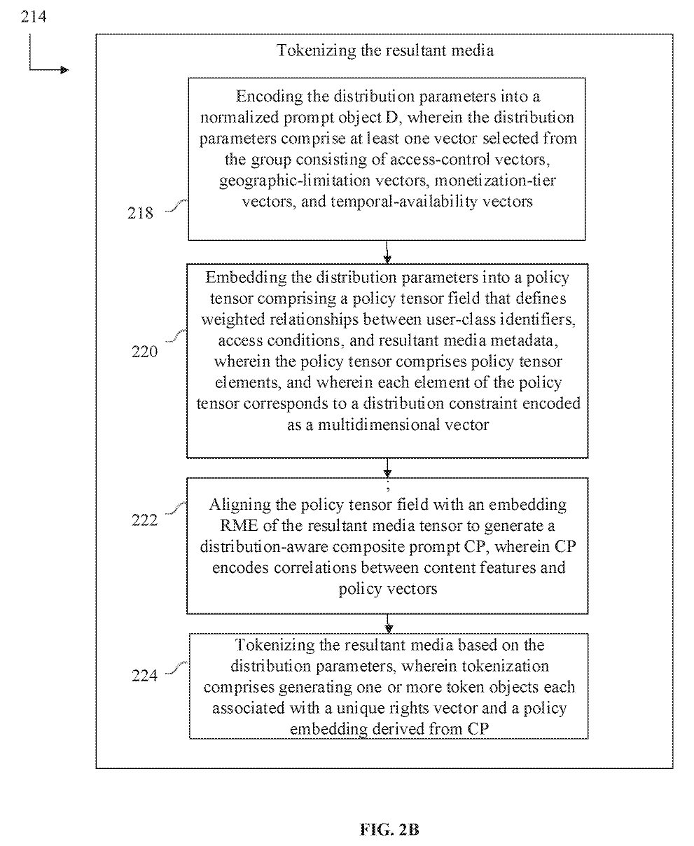

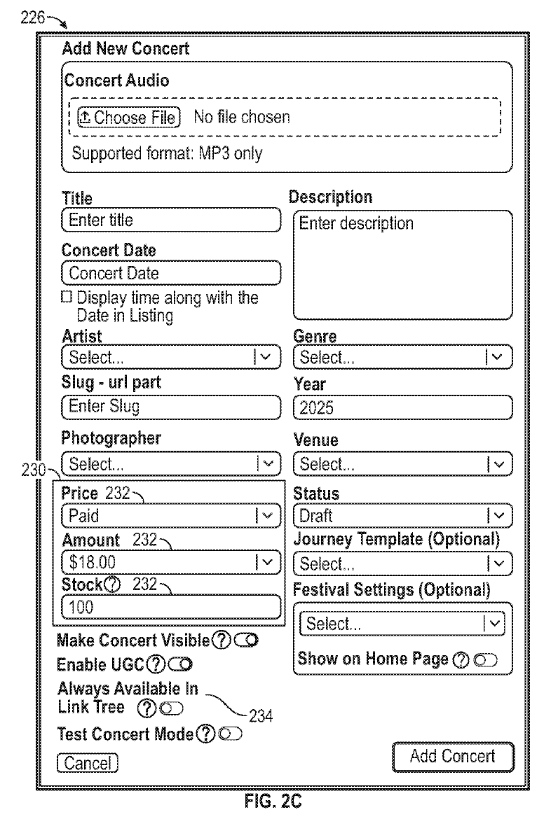

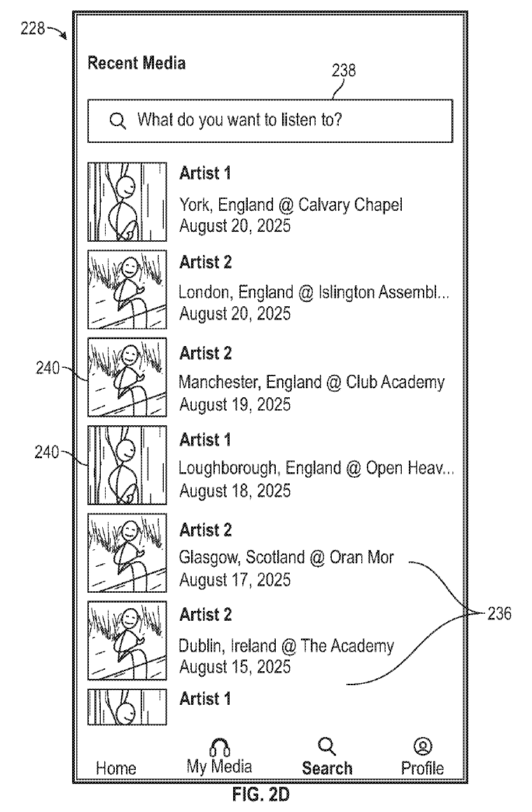

FIG. 2A is another flow diagram illustrating an example method 200 for sales and generation of the resultant media as in FIG. 1A that further includes distribution of the resultant media. Steps 202, 204, 206, 208, and 210 can be similar to those described with regard to FIG. 1A, and, for the sake of brevity, are not described further here. The method 200 can include receiving distribution limits from the first user class (Step 212). Based on the creation and combination of media, the method can introduce a governance step by receiving distribution limits from the first user class, which can be event organizers or administrators, or members of a band or its managerial staff. These distribution limits can define the conditions under which the resultant media can be accessed, shared, or monetized. Examples include specifying which user classes may download or view the final media, setting temporal restrictions such as embargo dates, or establishing tiered access levels (e.g., VIP attendees receive earlier or higher-quality versions). Distribution parameters may also include geographic limitations, paywall integration, or digital rights management (DRM) constraints to prevent unauthorized copying. The receiving of distribution limits can utilize secure configuration portals or administrator dashboards through which organizers input restrictions. These inputs can be stored as metadata within the media’s associated database entries, providing that all subsequent handling adheres to organizer intent. By providing the first user class to set such limits, the method balances wide distribution opportunities with event-specific control, ensuring exclusivity and compliance with contractual or licensing obligations. Thereby, the distribution limits can tailor the final media product to business models, whether that involves free community sharing, restricted fan-club releases, or commercial sale. It can formalize organizer authority, embedding their decisions directly into the technical workflow for distribution.

Once the resultant media has been generated and verified, the method can utilize a media distribution subsystem in a governance phase in which the first user class, which can be the event organizer, defines how that media may circulate. This can begin with the reception and encoding of distribution limits into a structured normalized prompt object. Each distribution parameter, which can include access level, geographic restriction, monetization model, or temporal availability, can be converted into a vectorized policy embedding. These embeddings are encoded alongside contextual metadata, such as user role hierarchies, contractual terms, or licensing tiers, to form a unified policy schema that the system can interpret mathematically. The encoded limits are represented as high-dimensional constraint tensors, each corresponding to a specific governance dimension—who, where, when, and how the resultant media can be used.

The system’s policy engine, which can be a portion of a media distribution subsystem, can integrate these constraint tensors with the existing resultant media tensor, effectively binding rights and access conditions directly to the media representation itself. Within this latent space, attention mechanisms can evaluate the compatibility between distribution vectors and the media’s metadata embeddings, which can include embeddings related to content category, token ID, and ownership lineage. This produces a normalized policy alignment map, providing that every access vector corresponds to a compliant permission state. The output can thereby be a distribution-aware prompt object, encapsulating both the media’s semantic representation and its encoded usage rules.

The method 200 can include tokenizing the resultant media (Step 214). The method 200 can provide for tokenizing the resultant media, embedding the defined constraints into a secure, enforceable structure. Tokenization can involve creating digital tokens—unique identifiers linked to blockchain or database records—that encapsulate ownership rights, access conditions, and provenance of the media. Each token may represent a distinct copy, license, or permission associated with the resultant media, providing that distribution complies with organizer-set rules. This step not only supports traceability but also allows for granular control, such as limiting the number of available downloads or enabling tiered pricing based on exclusivity. Tokenization can be implemented through cryptographic hashing, non-fungible token (NFT) frameworks, or secure license keys tied to user accounts. The resultant media itself may be encrypted, with decryption rights gated by token possession. Tokenization can also provide value-added features: secondary distribution tracking, audit trails of usage, and integration with e-commerce systems for resale or promotional purposes. By embedding the media in a tokenized framework, the method can extend beyond simple delivery into a controlled digital ecosystem, ensuring both participants and organizers retain confidence in authenticity and distribution fairness. Thereby, tokenization reinforces compliance with distribution limits and protects against piracy while opening opportunities for innovative monetization models.

Tokenization can translate the policy-bound prompt object into discrete digital tokens—cryptographically unique identifiers that map each permitted distribution instance to a verifiable on-chain or database record. Each token embodies a set of policy embeddings encoded as numerical weight vectors that describe access rights, duration, and ownership status. The process constructs a tensorized rights graph where nodes represent tokens and edges represent transactional or hierarchical relationships among rights holders. By embedding these vectors within the resultant media’s latent representation, the system ensures that distribution compliance is intrinsic to the media itself—not appended—enforcing policy through data structure rather than external regulation.

During activation, when a user requests access or download, the system can query the rights graph through a prompt-driven inference layer. The query generates a contextual embedding vector, which can include, for example, the user ID, device, and timestamp, which can be compared against the stored constraint tensors. Only if the similarity (such as dot-product similarity) between these embeddings satisfies the encoded distribution thresholds is decryption or access granted. This thereby provides fine-grained, explainable authorization rooted in tensor logic rather than static keys.

The method 200 can include making the resultant media available for download (Step 216). Based on resultant media creation, the resultant media can be made available for download by authorized users in accordance with any restrictions and tokenization. The resultant media—now refined, approved, and secured—can be published to the event-specific landing page or an integrated distribution portal. Access can be granted through direct download links, streaming platforms, or secure cloud hosting solutions, all of which respect the previously defined distribution rules. Download interfaces can include tiered options such as high-resolution video, compressed mobile-friendly formats, or bundled packages with bonus materials like photos or interviews. Secure servers can manage delivery, with encryption and digital rights enforcement ensuring compliance with access rights. The method 200 may log download activity, capturing user identities, timestamps, and device information to maintain accountability. In some embodiments, organizers can monetize this distribution by integrating payment systems, promotional codes, or subscription models directly into the landing page. The approval of media by the first user class prior to this step can provide quality and alignment with branding, while tokenization provides that each download event is traceable and verifiable. By providing a seamless, controlled download experience, the method can achieve dual objectives: preserving organizer control and delivering a value-enriched, event-specific media product to participants and consumers.

FIG. 2B is a flow diagram illustrating an example tokenization 214 of the resultant media. Tokenization 214 can include encoding the distribution parameters into a normalized prompt object D, wherein the distribution parameters comprise at least one vector selected from the group consisting of access-control vectors, geographic-limitation vectors, monetization-tier vectors, and temporal-availability vectors (Step 218). The method can include transforming the received distribution parameters into a structured normalized prompt object D, which can serve as the semantic and computational carrier for downstream policy embedding. Each parameter of D, such as access level, geography, pricing tier, or availability window, can be represented as a distribution vector, with each vector occupying a dimension in the prompt schema’s multidimensional space. The encoding process applies embedding techniques to translate human-readable policies into numerical representations that preserve relationships between rule types and event metadata. These embeddings are stored as elements of D, where each element represents a context-conditioned encoding of the first user class’ intent. For example, an access-control vector may be aligned with specific user-class identifiers, while a monetization-tier vector encodes value weighting across distribution channels. The prompt object D is normalized to eliminate redundancy, providing that all embeddings conform to a unified coordinate system for later tensor alignment.

Tokenization 214 can include embedding the distribution parameters into a policy tensor comprising a policy tensor field that defines weighted relationships between user-class identifiers, access conditions, and resultant media metadata, wherein the policy tensor comprises policy tensor elements, and wherein each element of the policy tensor corresponds to a distribution constraint encoded as a multidimensional vector (Step 220). The encoded distribution vectors from the normalized prompt object D can be embedded into a policy tensor field, thereby creating a structured data space that defines weighted relationships among user classes, access conditions, and resultant media metadata. The policy tensor can function as a multidimensional matrix in which each element represents a discrete distribution constraint, including, for example, geographic scope, authorization level, or time-based validity, encoded as a numerical vector. During embedding, the system can apply tensor mapping algorithms that correlate the policy embeddings to specific attributes of the resultant media, such as file identifiers, event tags, or version references. Each policy tensor element can include a weighting coefficient that determines its influence on overall distribution behavior. This creates a field of interrelated policy vectors capable of dynamic computation when queried or compared against user requests. By embedding distribution parameters in this manner, the method provides that each rule or restriction can be not merely stored, but mathematically represented as part of an active, computable field. This tensor-based embedding thereby can transform static policy declarations into responsive, encoded structures that can be aligned, queried, and tokenized.

Tokenization can include aligning the policy tensor field with an embedding RME of the resultant media tensor to generate a distribution-aware composite prompt CP, wherein CP encodes correlations between content features and policy vectors (Step 222). During alignment, the method includes generating a distribution-aware composite prompt (CP) by correlating policy vectors from the tensor field with content features encoded in the resultant media embedding RME. This process identifies how each policy constraint applies to specific segments or versions of the resultant media. For instance, an access-control vector may be linked to a particular resolution tier, or a geographic-limitation vector may be aligned to regional distribution embeddings. Thereby, agreement between the policy tensor field with the resultant media embedding (RME) is provided for execution.

Based on the alignment, the tokenization can include tokenizing the resultant media based on the distribution parameters, wherein tokenization comprises generating one or more token objects each associated with a unique rights vector and a policy embedding derived from CP (Step 224). The method can include executing tokenization, producing discrete token objects, each representing a unique access unit governed by embedded policy data. Every token object can carry a rights vector and policy embedding derived from CP, which specify who can access the content, under what conditions, and for how long. These tokenized representations are stored in association with the resultant media tensor, providing that distribution enforcement occurs automatically at the point of access. The method thereby transforms the resultant media into a governed asset, where encoded distribution parameters are inseparable from the digital object itself, providing that rights, access, and monetization rules are executed algorithmically.

FIG. 2C is an example interface 226 for receiving distribution limits 230 according to the method of FIG. 2A. This interface 226 can provide that the organizer to able to specify how, when, and to whom the resultant media may be accessed, shared, or monetized. The organizer can input parameters 232 such as access-control rules 234 (e.g., only attendees, VIP tiers, payment status, or public release), geographic limitations, pricing structures, subscription tiers, or time-based release windows. The interface 226 can utilize dropdown menus, toggle selectors, text-entry fields, and guided configuration prompts that provide each distribution parameter 232 is clearly defined before being submitted. Once entered, these distribution limits 230 can be transmitted to a system, where they are encoded into a normalized prompt object and subsequently embedded into a policy tensor for algorithmic enforcement. The interface 226 can further present previews or summaries of the selected distribution configuration, enabling the organizer to verify correctness before final confirmation. In some implementations, the interface includes explanatory tooltips or workflow indicators describing how the system will tokenize the resultant media based on the distribution limits.

FIG. 2D is an example interface 228 for downloading the resultant media in accordance with the method of FIG. 2A. This interface 228 can be presented when the resultant media has been generated, approved, and made available for download in accordance with the previously defined distribution limits. Based on the alignment of the event-specific media with the master recording and production of the resultant media tensor, the media can be published to the event-specific landing page or distribution portal 238 accessible to authorized users. The interface 228 can include download buttons, file-format options (e.g., MP4, WAV, bundled packages), streaming windows, or preview thumbnails 240. In some implementations, depending on the organizer’s selected distribution limits, users may be required to authenticate, redeem tokenized access rights, or complete a purchase prior to download. In some implementations which leverage tokenization, each download request can trigger a rights-verification process wherein a system compares the user’s rights vector with the policy tensor associated with the media. The interface 228 can also include status indicators such as download progress bars, content descriptions, timestamps, and metadata summaries describing the event. In some implementations, users can access multiple versions of the resultant media—such as highlight edits, multi-angle composites, or full-length videos—based on their assigned permissions.

FIG. 3A is another flow diagram illustrating an example method for sales and generation of the resultant media as in FIG. 1A that further includes that includes verifying a physical presence. Steps 302, 304, 306, 308, and 310 can be similar to those described with regard to FIG. 1A, and, for the sake of brevity, are not described further here. The method 300 can include verifying a physical presence (Step 312). Verifying physical presence can utilize a validation mechanism to verifying the physical presence of members of the second user class at the event before allowing them to contribute media. This verification provides that only genuine attendees—those who were physically at the event—are able to upload photos, videos, or audio recordings to the event-specific landing page. By doing so, the method can prevents unauthorized or irrelevant media submissions that could dilute or compromise the authenticity of the resultant media product. Several mechanisms, alone or in tandem, can be employed to perform this verification. One approach involves location-based services, such as GPS data from mobile devices, Bluetooth® beacons, or Wi-Fi triangulation within the venue. Further, ticket-scanning systems or QR codes (which can be only posted at the event) can be linked to user accounts, cross-verifying entry with upload permissions. In some embodiments, biometric or environmental inputs, such as time-stamped facial recognition at entry points or device proximity checks, can provide robust confirmation of presence. Verification can utilize secure back-end systems that authenticate users in real time before granting them access to upload functions. This can provide that all media is grounded in the lived experiences of verified participants. Beyond authenticity, the presence verification step can enhance trust in the final product for both organizers and consumers, as it provides that the event-specific media originates exclusively from those who were part of the live event. By filtering contributors through this gatekeeping process, the method can preserve the integrity, exclusivity, and narrative cohesion of the resultant media.

Verification of physical presence can occur utilizing. login credentials. The login credentials can operate as a first-tier identity and presence confirmation mechanism, integrating authentication data into the system’s normalized prompt object for each participant. For example, when an attendee arrives at the venue, a system can prompt a secure login via the event-specific landing page or a companion mobile application. Each login instance can generate a credential embedding, which can be a vector representation of user ID, authentication timestamp, and network signature. These embeddings can be compared against a preloaded access registry containing vectors corresponding to approved attendees. The system can align these vectors within a similarity tensor space, thereby providing that only users whose credentials exhibit a high semantic and temporal correlation with registered event data are granted upload access.

To strengthen presence verification utilizing login credentials, the method can incorporate real-time parameters such as IP geolocation, device MAC address, and session latency, which can each be encoded as additional verification vectors. When combined, these elements can form a multimodal presence tensor, correlating authentication data with network context. This tensor can then be evaluated through a presence-validation model that measures whether the login activity aligns with physical proximity and event timing. If the correlation exceeds the trained threshold, the user is confirmed as present at the event. Because login data is cryptographically time-stamped, attempts to authenticate remotely or outside the event timeframe yield low-similarity vector responses, preventing false verification. Thereby, the login credentials can be utilized to form contextualized, tensor-encoded indicators of verified presence, providing that subsequent uploads and media contributions originate from authenticated participants actually attending the live event.

Using QR code tickets can also provide an event-specific method of verifying physical presence while maintaining efficiency and data integrity. In an example, each attendee can receive a unique, cryptographically generated QR code upon registration. When scanned at the venue, a system can encode the ticket’s data—including a user ID, seating section, and timestamp—into a normalized prompt object. This object can be represented as a verification embedding, where each attendee’s entry record can be a vector in the system’s attendance tensor field. At the time of upload, the system can cross-reference the attendee’s QR-encoded vector with the database of scanned entries. Because each QR code is token-unique and includes a hash derived from event parameters, unauthorized duplication is computationally infeasible. A presence verification model can calculate a similarity metric between the attendee’s upload session vector and the stored QR-code embedding. Only when these vectors align within an acceptable margin of cosine similarity, for instance, indicating matching time, location, and identity, is media upload access granted. The method may further augment this process by linking QR verification data with the device’s onboard sensors (e.g., GPS, Wi-Fi triangulation) to confirm spatial congruence. The resulting verification tensor thereby combines both credential and positional vectors, generating a high-confidence probability of actual physical attendance. The encoded prompt object then logs this verification event as part of the user’s contribution metadata. By integrating QR code authentication with tensor-based presence modeling, the system transforms a simple entry scan into a multimodal proof of attendance, ensuring that only verified attendees can contribute event-specific media, thereby preserving the authenticity and exclusivity of the resultant media corpus. Additional contextual data, such as Wi-Fi access point IDs or Bluetooth signal strengths, can be incorporated as supporting feature vectors.

Verification can also occur using QR codes displayed exclusively on physical posters at the event site. This introduces a location-tethered proof-of-presence mechanism. In an example configuration, QR codes are never distributed electronically; instead, they are printed on signage, wristbands, or posters placed within the venue. Each code can include an encoded, randomized alphanumeric token that, when scanned, triggers creation of a localized normalized prompt object. This prompt contains vectors representing the device ID, scan timestamp, and the unique hash of the poster-code, which can correspond to a pre-registered geospatial zone in the system’s database. As these QR codes exist only in the physical event environment, the act of scanning serves as an implicit location verification. A system can encode each scan into a presence embedding, placing it within a geospatial tensor field. A presence-validation module can compare this tensor against an event’s authorized spatial signature, which can be encoded during venue setup, to confirm that the scan originated within legitimate boundaries. This physical-poster method eliminates the need for prior ticket ownership or login, allowing ad-hoc attendees to verify presence simply by interacting with on-site media. Because each QR code decays or rotates dynamically through time-locked hashes, remote users cannot replicate the verification vectors. Once confirmed, the user’s prompt object becomes authorized for media upload, tagged with a verified-presence token embedding. This provides that every contribution to the event-specific landing page originates from devices that physically interacted with event-exclusive signage, thereby utilizing the event location itself as a cryptographically verifiable vector.

Verification can also occur using tokenized passes. Verification using tokenized passes can leverage blockchain and/or distributed-ledger identifiers to encode both attendance rights and proof of physical presence. In an example, each attendee can receive a tokenized credential, represented as a non-fungible or semi-fungible digital asset embedded with metadata vectors describing identity, seat allocation, and event time window. When the attendee arrives at the venue, their mobile wallet transmits this token through a proximity-enabled handshake, such as near field communication or Bluetooth Low Energy, to the event’s verification gateway. The gateway can decode the token’s embedded vectors and generate a normalized prompt object, combining the credential’s unique token ID with live environmental features, which can include device signature and geolocation. This prompt object is thereby a presence tensor, expressing both identity and spatial correlation. The system can then perform an on-chain validation of the token, confirming its authenticity and unused status, before embedding it back into the system’s active attendance matrix.

During media upload, the attendee’s contribution can include the token’s cryptographic hash, providing traceability to a verified, on-site participant. The system can cross-check this hash against the event’s live attendance tensor, confirming both legitimacy and locality. In some embodiments, token transfers outside the venue or before the event trigger automatic invalidation by adjusting the token’s vector weights to zero similarity based on current geospatial embeddings. Thereby, this provides a tamper-resistant, auditable verification system in which tokenized embeddings encode the physical, temporal, and transactional dimensions of the user's physical presence.

Verification can also occur through geofencing. Geofencing can utilize spatial encoding to confirm that attendees are physically located within a defined geographic perimeter before granting upload privileges. A member of the first user class, such as, the event organizer, can define a geofence—specified by latitude, longitude, and radius parameters—which can be stored as a boundary tensor within the system. When an attendee accesses the event-specific landing page, their device can transmit GPS coordinates, Wi-Fi signatures, or nearby cell tower IDs, which can be encoded into a location prompt object. This object can include multidimensional position vectors representing real-time spatial coordinates. The system can compare these vectors against the stored boundary tensor using a spatial-similarity function. If the user’s embeddings fall within the encoded radius and temporal window, the system can generate a presence-validation embedding with a high confidence score. To further secure this process, the system may integrate motion vectors derived from accelerometer and gyroscope data to confirm natural human movement patterns within the venue, which can distinguish genuine attendees from static or artificial GPS signals. The resulting verification tensor can include geolocation, motion, and network-context vectors, thereby forming a robust encoded proof of physical presence. Once verified, the normalized prompt object is authorized for event-specific media uploads, and its embedding is stored alongside any submitted content.

FIG. 3B is an example interface 314 for verification of physical presence in accordance with the method of FIG. 3A. Physical presence of a member of the second user class at the live event can be verified prior to permitting any submission of event-specific media. This interface 314 can function as an authentication layer that precedes access to the media-upload environment shown elsewhere in the drawings. The layout may include prompts 316 for the user to initiate a presence-verification action such as scanning a QR code, confirming device geolocation, authenticating through login credentials 318, or presenting a tokenized event pass. Based on authentication, the interface 314 can guide the user through the required verification steps by displaying instructions, scanning windows, permission dialogs, or device-sensor prompts. In some implementations, the interface 314 can include an embedded QR-scan module or a button 320 that triggers geofencing confirmation, which compares the device’s current coordinates to a predefined geospatial boundary associated with the event venue. The interface 314 can also incorporate indicators showing successful or failed verification, such as “Presence Confirmed,” “Outside Venue Boundary,” or “Verification Required.”

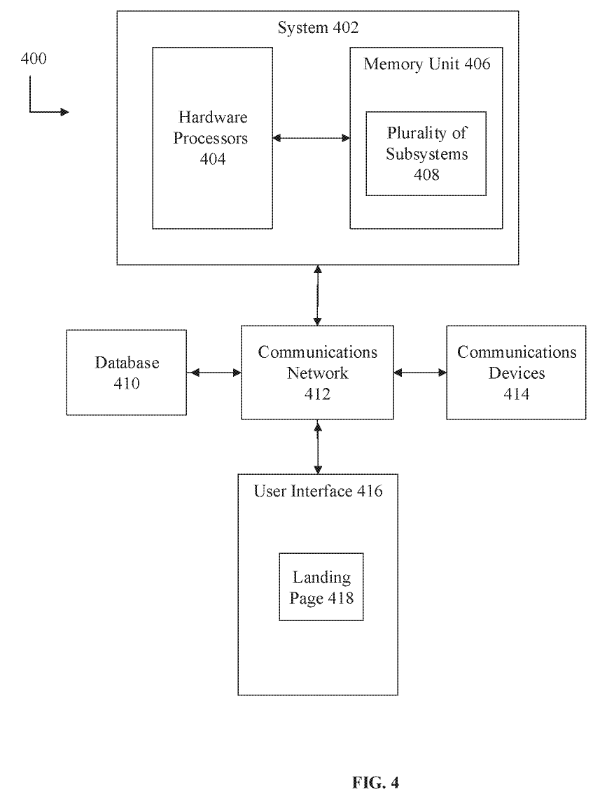

FIG. 4 depicts an example architecture 400 in which the methods of FIGS. 1-3 of the present embodiments may operate. The architecture 400 can include a system 402, database 410, communications network 412, communications devices 414, and user interface 416, which can include a landing page 418. The system 402 can include hardware processors 404 and a memory unit 406.

The architecture 400 can include a system 402 that includes a hardware processor 404. The one or more hardware processors 404, as used herein, means any type of computational circuit, such as, but not limited to, a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 404 may also include embedded controllers, such as generic or programmable logic devices or arrays, application-specific integrated circuits, single-chip computers, and the like.

The memory unit 406 can include a plurality of subsystems 408. The memory unit 406 may be the non-transitory volatile memory and the non-volatile memory. The memory unit 406 may be coupled to communicate with the one or more hardware processors 404, such as being a computer-readable storage medium. The one or more hardware processors 404 may execute machine-readable instructions and/or source code stored in the memory unit 406. A variety of machine-readable instructions may be stored in and accessed from the memory unit 406. The memory unit 406 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 406 can include the plurality of subsystems 408.

The plurality of subsystems 408 can be stored in the form of machine-readable instructions on any of the above-mentioned storage media and may be in communication with and executed by the one or more hardware processors 404. A computer system (standalone, client or server computer system) configured by an application may constitute a “module” (or “subsystem”) that is configured and operated to perform certain operations. In one embodiment, the “module” or “subsystem” may be implemented mechanically or electronically, so a module can include dedicated circuitry or logic that is permanently configured (within a special-purpose processor) to perform certain operations. In another embodiment, a “module” or “subsystem” may also include programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

The architecture 400 can include a database 410. The database 410 may include, but not limited to, storing, and managing data related to the user set, including organizational structure, tasks, and priorities. The database 410 can serve as a central repository for all relevant data for cross-referencing. The database 410 can include structured and unstructured data supporting the operation of the system 402 and its subsystems 408. This can include event metadata (titles, locations, and dates), user-class credentials, access permissions, and distribution limits defined by organizers. The database 410 can also store uploaded event-specific media files, master media recordings, and their associated embeddings, vectors, or tensor references used for processing. Additional stored data can include normalized prompt objects, policy tokens, transaction logs, and resultant media references. Together, these records enable the system to authenticate users, align multimodal media inputs, manage content rights, and deliver event-specific media through the landing page 418.

The architecture 400 can include a communications network 412. The communications network 412 can include one or more communications networks 412 and can be, but not limited to, a wired communication network, a wireless communication network, or a combination of wired communication networks and wireless communications networks. The wired communication network may include, but not be limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may include, but not be limited to, at least one of: wireless fidelity (wi-fi), cellular networks (including 4G (fourth generation), 4G (fifth generation), and 4G (sixth generation) networks), Bluetooth, ZigBee, long-range wide area network (LoRaWAN), satellite communication, radio frequency identification (RFID), advanced IoT protocols, mesh networks, non-terrestrial networks (NTNs), near field communication (NFC), and the like. The communication networks 412 can be configured to facilitate data exchange and communication between the system 402 and the database 410 for real-time data analysis.

The architecture 400 can include communications devices 414. The communications devices 414 can be one or more communication devices 414 and may represent various network endpoints, such as, but not limited to, user devices, mobile devices, smartphones, Personal Digital Assistants (PDAs), tablet computers, phablet computers, wearable computing devices, Virtual Reality / Augmented Reality (VR/AR) devices, laptops, desktops, display interface panels, control panels, human machine interface panels, liquid crystal display (LCD) screens, light-emitting diode (LED) screens, and the like. The one or more communication devices 414 can be configured to function as an intermediate unit between the system 402 and one or more users. The one or more communication devices 414 can be equipped with a user interface that allows the one or more users to interact with the system 402. The user interface may include graphical displays, touchscreens, voice recognition, and other input/output mechanisms that facilitate easy access to data and control functions. Any other instructions may be provided by one or more users to the system 402 via the user interface 416.

The architecture 400 can include the user interface 416 on a user device, which can as a point of interaction between the end-user and the system 402. This device may be a smartphone, tablet, smartwatch, laptop, or any network-enabled computing platform capable of running a client-facing application. Within the architecture 400, the user interface 416 can function as the medium for data collection, delivery, and bidirectional communication with the backend system 402 through the communications network 412. The user interface 416 can be the central interaction layer through which both the first and second user classes engage with the system. It can provide a gateway for creating, managing, and consuming event-specific content, offering an intuitive environment where technical workflows are translated into accessible user actions. For members of the first user class—such as event organizers or administrators—the user interface 416 can provide dashboards for configuring event metadata, setting access restrictions, and defining distribution limits. These can include graphical tools for drag-and-drop configuration, calendar integration for scheduling, and administrative approval workflows for media validation. Members of the first user class can also receive analytics feedback through the user interface 416, including metrics on user engagement, number of uploads, download activity, and token utilization.

For members of the second user class—which can be attendees or participants—the user interface 416 can provide streamlined upload and interaction. Upload forms, camera integration, and simplified drag-and-drop zones can allow participants to contribute photos, videos, and audio recordings. The user interface 416 can include real-time status indicators, such as progress bars for uploads, or notifications confirming successful submission. To ensure trust, the user interface 416 can also communicate verification prompts, asking users to enable location data or scan a ticket code to confirm physical presence before enabling uploads.

The user interface 416 can be optimized for cross-platform compatibility, functioning equally well on web browsers, mobile apps, and venue-specific kiosks. A layered design approach can provide tiered visibility, where certain sections are only displayed based on user class. Security can be embedded at the user interface 416 level, including encrypted sessions, authentication prompts, and permissions enforcement. By balancing usability with security, the user interface 416 can provide that both casual participants and professional organizers can interact seamlessly with the underlying system, making the technology accessible while safeguarding event integrity.

The landing page 418 can be the event-specific digital hub generated within the broader user interface 416 framework. It is designed not only as a media submission portal but also as a branded, content-rich representation of the event itself. Each landing page can be tied directly to a single event, containing metadata such as event title, performer or speaker details, date, and location. Unlike a generic site, it contextualizes contributions within the narrative of a specific occasion, enhancing both user engagement and media relevance.

For the second user class, the landing page 418 can function as the primary upload interface. Here, attendees can submit their event-specific media—whether photographs, video clips, or audio snippets—directly through structured forms or embedded camera integrations. The page may provide usage guidelines, preview features, and automatic tagging tools to ensure uniformity and compliance. To reinforce authenticity, the landing page can integrate with verification systems, confirming physical presence before uploads are permitted.

For the first user class, the landing page 418 can double as a distribution point. Based on generation of the resultant media, the landing page 418 becomes a portal for controlled distribution. Features may include order forms, payment processing, download links, or embedded streaming windows. Distribution can be further customized through dynamic access tiers, ensuring that the resultant media is delivered according to the limits and tokenization rules.

The landing page 418 can be highly customizable, allowing branding, logos, color schemes, and sponsor messaging. It can also integrate social media share buttons, countdown timers for media release, or e-commerce modules for monetization. By centralizing both collection and distribution, the landing page 418 can be the focal point of the event’s digital lifecycle, embodying both the communal aspects of participant engagement and the professional polish of curated media delivery.

Those of ordinary skilled in the art will appreciate that the hardware depicted in FIG. 4 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 402 as is unique to the present disclosure or necessary for an understanding of the present disclosure is depicted and described. The remainder of the construction and operation of the system 402 may conform to any of the various current implementations and practices that were known in the art.

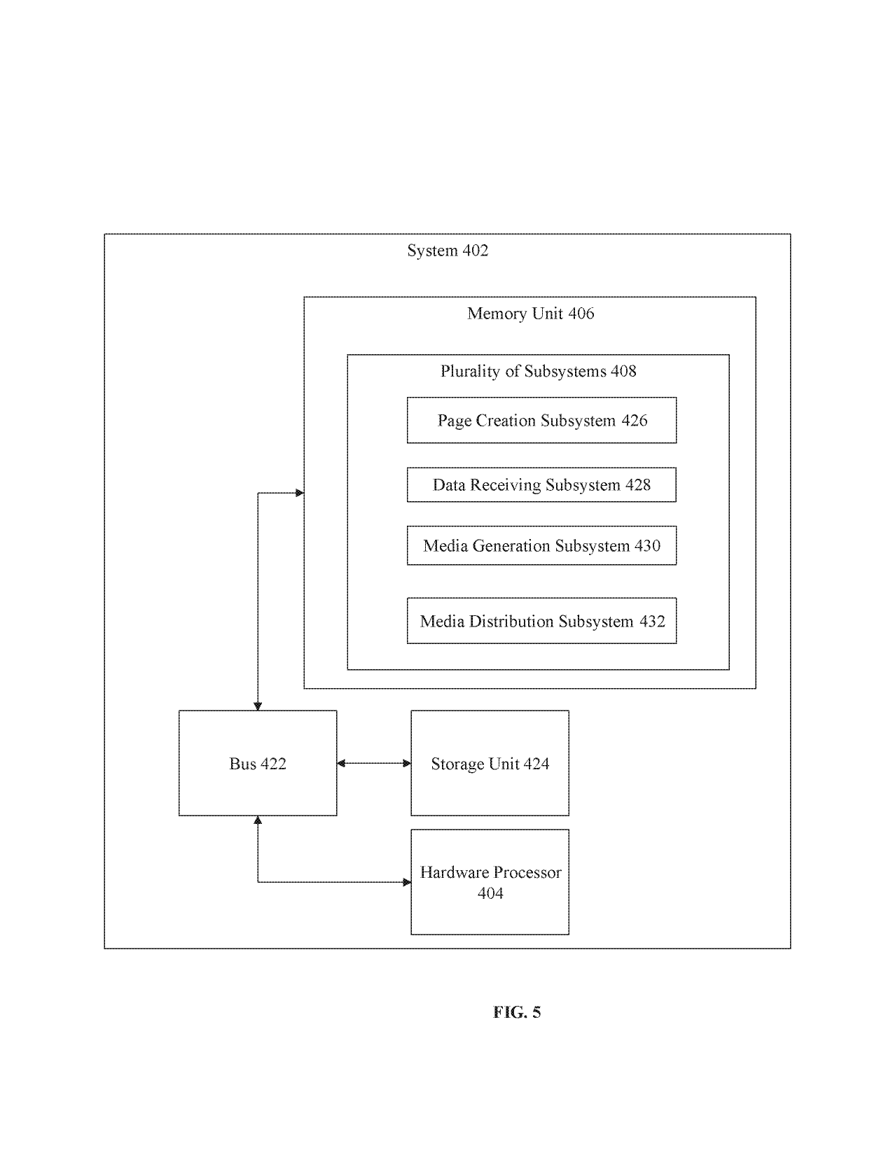

FIG. 5 is a block diagram showing an example system 402 of the present embodiments along with its corresponding subsystems. The system 402 can include a memory unit 406, bus 422, storage unit 424, and hardware processor 404. The memory unit 406 can include a plurality of subsystems 408, which can include a page creation subsystem 426, a data receiving subsystem 428, a media generation subsystem 430, and a media distribution subsystem 432.

The system 402 can include a memory unit 406. The memory unit 406 can be identical to the memory unit 406 described in FIG. 4, and for the sake of brevity, is not described further here.

The system 402 can include a bus 422. The system bus 422 can function as a central conduit for data transfer and communication between the one or more hardware processors 404, the memory unit 406, and the storage unit 424. The system bus 422 facilitates the efficient exchange of information and instructions, enabling a coordinated operation of the system 402. The system bus 422 may be implemented using various technologies, including, but not limited to, parallel buses, serial buses, or high-speed data transfer interfaces such as, but not limited to, at least one of a: universal serial bus (USB), peripheral component interconnect express (PCIe), and similar standards.

The system 402 can include a storage unit 424. The storage unit 424 may be a cloud storage or the database 410, such as those shown in FIG. 4. The storage unit 424 may store, but not limited to, recommended course of action sequences dynamically generated by the system 402. These action sequences can include data-obtaining, data processing, instruction interpreting, adaptive, and the like. The storage unit 424 may be any kind of database such as, but not limited to, relational databases, dedicated databases, dynamic databases, monetized databases, scalable databases, cloud databases, distributed databases, any other databases, graph databases, vector databases, and a combination thereof.

The system 402 can include a page creation subsystem 426. The page creation subsystem 426 can provide the technical foundation for generating event-specific landing pages that can act as the central hubs of interaction. This subsystem can be responsible for enabling a member of the first user class, such as an event organizer, to design and publish a unique landing page tied to a specific event. It can integrate tools for inputting metadata—such as event name, date, time, location, and performer details—and offers customization features to include branding, logos, sponsor messaging, and thematic visual elements. Beyond aesthetics, the page creation subsystem 426 can implement structural elements like upload portals, distribution modules, and order forms, providing that the page is more than a static web environment. It can be built to support dynamic functionality, allowing attendees to upload event-specific media while also enabling organizers to monitor submissions, approve content, and configure access restrictions. Technical implementation can utilize template-driven design engines, database connectivity for event storage, and APIs for payment, authentication, and content verification. By combining usability and security, the page creation subsystem 426 can provide that organizers can establish a digital focal point for the event without requiring specialized technical expertise. In doing so, it provides that every event receives a customized, secure, and functional digital presence, aligning with the overall goal of collecting, combining, and distributing resultant media.

The system 402 can include a data receiving subsystem 428. The data receiving subsystem 428 can be a collection mechanism for all event-specific media uploaded by members of the second user class. Based on establishment of access and verification, the data receiving subsystem 428 can manage the ingestion of diverse media formats, including photos, video clips, and audio recordings. It can provide a robust infrastructure capable of handling high-volume uploads in real time, ensuring scalability for large events with thousands of participants. The data receiving subsystem can utilize processes such as metadata tagging, time-stamping, and user association, which can organize incoming files for later synchronization with the master recording. The data receiving subsystem 428 can also perform preliminary filtering and validation, such as checking file formats, enforcing size limitations, and employing AI modules to detect inappropriate or irrelevant content. The data receiving subsystem 428 can interface with presence verification systems, confirming that each piece of media originates from a verified attendee before acceptance. On the back end, data storage can be managed through secure cloud environments or distributed databases with redundancy and backup to prevent loss. The subsystem also enables queueing and prioritization, ensuring orderly processing during peak submission times. By collecting and structuring the raw contributions of participants, the data receiving subsystem 428 can provide the foundation for subsequent media generation. Its role provides that the final dataset is authentic, comprehensive, and prepared for integration into the resultant media, preserving both technical integrity and experiential richness.

The system 402 can include a media generation subsystem 430. The media generation subsystem 430 can be responsible for transforming heterogeneous media inputs into a cohesive, polished resultant media product. This subsystem can merge crowd-sourced content gathered via the data receiving subsystem 428 with the official master recording to produce a hybrid artifact that balances professional quality with authentic participant perspectives. Technical workflows within the media generation subsystem 430 can include synchronization algorithms, which align user-contributed photos or videos with the timing of the master audio or video feed. AI-driven models, such as neural networks or vision-language architectures, can be employed to enhance resolution, reduce noise, and intelligently stitch disparate inputs into a seamless, synchronized narrative. For example, short video clips from attendees can be overlaid on the master audio, creating multi-angle perspectives, while still photographs can be transformed into time-aligned slideshows. Beyond media integration, the media generation subsystem 430 can also handle editing tasks such as color correction, sound equalization, and transitions to ensure professional polish. In some embodiments, members of the first user class, such as organizers, can be able to preview and approve generated content before release, further customizing the product. The media generation subsystem 430 thereby can convert fragmented, user-generated data into a unified, distributable asset. By blending authenticity and quality, it provides that the resultant media embodies both the official record of the event and the lived experiences of its attendees, making it valuable to consumers, performers, and organizers.

The system 402 can include a media distribution subsystem 432. The media distribution subsystem 432 can govern how the resultant media is delivered to intended audiences in compliance with defined rules. Based on media generation and approval, this subsystem can utilize the mechanisms for controlled release. It may provide download portals, streaming access, or integration with third-party platforms, which can be managed through the event-specific landing page. The media distribution subsystem 432 can enforce the distribution limits and tokenization rules established earlier, providing that only authorized users gain access and that media sharing complies with organizer intentions. The media distribution subsystem 432 can incorporate encryption, license key management, digital rights management systems, and combinations thereof, thereby preventing unauthorized duplication or piracy. It can also support tiered access, enabling premium features such as high-definition downloads or early release windows for select user groups. The media distribution subsystem 432 can also include payment processing, promotional codes, and subscription models, thereby providing organizers with the ability to monetize the resultant media. Analytics functions can also be included in the media distribution subsystem 432, tracking downloads, user demographics, and playback behavior to provide insights into audience engagement. By combining security, flexibility, and scalability, the media distribution subsystem 432 can provide that the resultant media is not only delivered seamlessly but also protected against misuse. It can close the loop of the workflow, turning collected and processed content into a consumable, monetized product that preserves both event exclusivity and organizer control.

Though few components and a plurality of subsystems 408 are disclosed in FIG. 4, there may be additional components and subsystems which are not shown, such as, but not limited to, ports, routers, repeaters, firewall devices, network devices, the database 410, network attached storage devices, assets, machinery, instruments, facility equipment, emergency management devices, image capturing devices, any other devices, and combination thereof. The person skilled in the art should not be limiting the components/subsystems shown in FIG. 4. Although FIG. 4 illustrates the system 402, and the one or more communication devices 414 connected to the database 410, one skilled in the art can envision that the system 402, and the one or more communication devices 414 may be connected to several user devices located at various locations and several databases via the one or more communication network 412.

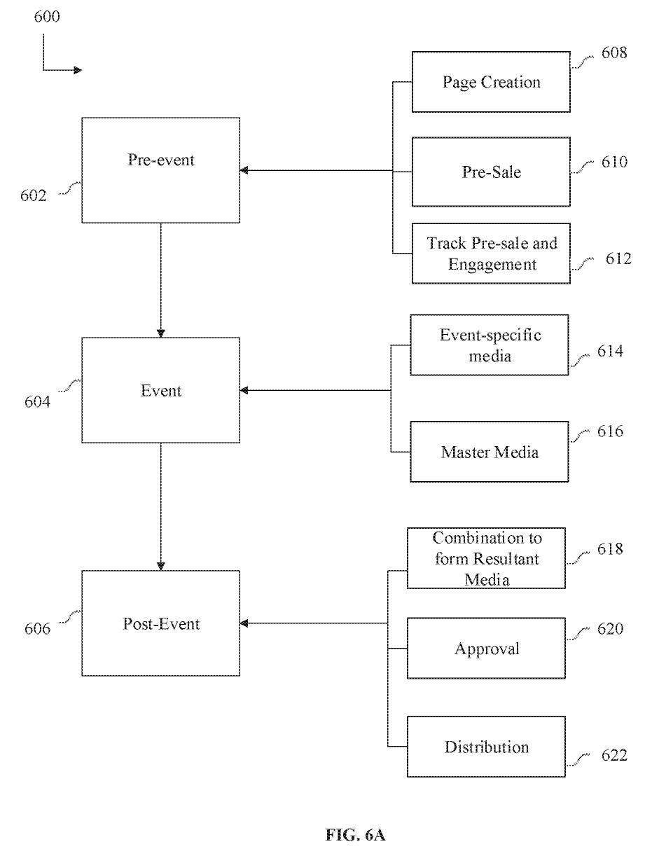

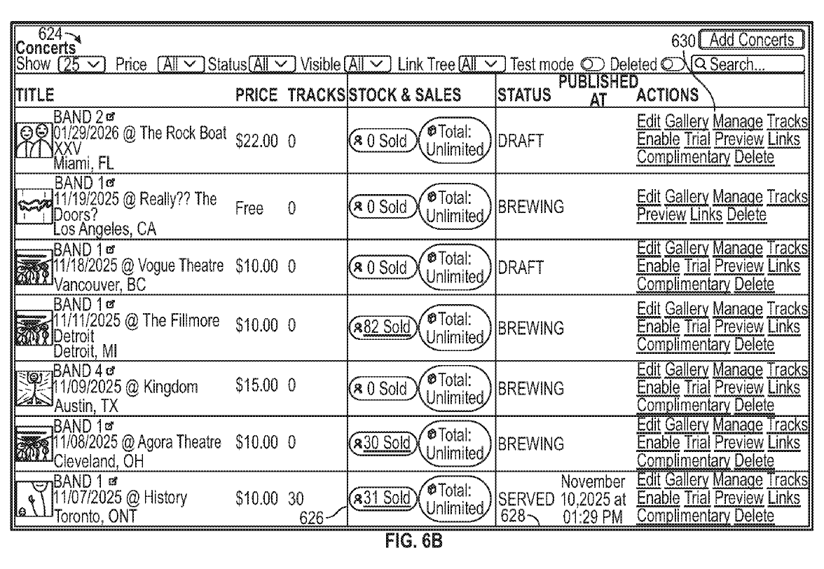

FIG. 6A is an example data flow 600 of the present embodiments organized into pre-event 602, event 604, and post-event 606 phases. At the pre-event 602 phase can be the preparation activities that enable the embodiments to capture, curate, and distribute media in an organized and secure manner once the live event occurs. At this point, page creation 608 can be performed utilizing the page creation subsystem 426. Persons from the first user class can create an event-specific landing page, serving as a central hub for subsequent interactions. The landing page can utilize metadata such as event title, location, performers or participants, logos, and branding. Beyond static elements, this stage can integrate structural features including upload portals for future media submissions, modules for order placement, and placeholders for download or distribution functionality. Pre-sale 610 may also occur at the pre-event 602 phase, offering early access opportunities to consumers. Pre-sale options can include ticket sales, digital vouchers for the resultant media, or tiered access packages that reserve premium versions of the final product. These pre-sale 610 activities can generate valuable engagement data, which can feed into tracking pre-sale and engagement 612. This tracking captures metrics such as ticket volume, geographic distribution of purchasers, anticipated attendance, and predicted demand for resultant media products. The data can inform organizers of consumer interest, allowing them to scale infrastructure for uploads, storage, and distribution accordingly. Pre-event 602 can also set the groundwork for authentication and access control. Mechanisms for verifying user classes, such as login credentials, QR code integrations, or geofencing, can be configured in this stage. These controls ensure that once the event begins, only validated second-user class participants will be permitted to upload content. Organizers can also predefine distribution limits and tokenization policies, storing them in the system’s backend for automatic enforcement later. Thereby, the pre-event 602 phase can establish the digital ecosystem of the event, balancing promotional objectives, security preparations, and infrastructure readiness. It can utilize abstract planning into a functional environment where both organizers and future attendees are aligned, paving the way for authentic, controlled, collaborative media.

The event 604 phase can be the live operational phase, where the implementations can transition from preparation to active collection and recording of media. Two information flows can converge here: event-specific media 614 contributed by the second user class, and master media 616 captured professionally by event organizers or production teams. Event-specific media 614 can include photos, short videos, or audio clips uploaded by attendees in real time through the event-specific landing page. These submissions can be received via the data receiving subsystem 428, which can verify the physical presence of each contributor before accepting uploads. Each file can be time-stamped, tagged with metadata, and stored in secure databases for later synchronization. Real-time monitoring may filter inappropriate content, compress large files for rapid transfer, and queue submissions during peak periods. In parallel, master media 616 can be captured through official channels such as stage cameras, professional microphones, or broadcast equipment. This high-fidelity baseline can provide technical polish and continuity. Metadata such as camera angle, track identifiers, or time codes are embedded to aid synchronization with attendee contributions. The coexistence of user-generated and professional inputs during the event 604 phase reflects the embodiments’ ability to merge diverse perspectives into a unified product. Attendees can provide authenticity and variety, while the master recording can provide professional quality and a baseline for synchronization. By securing both flows, the event 604 phase establishes the comprehensive dataset required for combination to form resultant media 618 in the next phase.

At the post-event 606 phase can be the culmination of prior preparation and collection activities, transforming raw inputs into a finished, distributable product. The combination to form resultant media 618 can be where the media generation subsystem 430 merges attendee contributions 614 with the master recording 616. This combination can employ AI-driven models such as neural networks or vision-language models to align and enhance inputs. For example, video clips can be synchronized with professional audio tracks, while photographs can be sequenced into time-aligned slideshows or layered into multi-perspective visualizations. Based on creation of the resultant media, approval 620 can occur. Members of the first user class can review the compiled content for accuracy, branding consistency, and quality standards. This governance can provide that the final product represents both the authenticity of user perspectives and the professional polish of official recordings. Based on approval 620, the embodiments can undergo distribution 622, which can be performed by the media distribution subsystem 432. Distribution rules established previously, such as at the pre-event 602 phase, can be enforced here, including tokenization, access limitations, and digital rights management protections. The resultant media can then be made available for download, streaming, or commercial sale, with options for tiered pricing, promotional codes, or subscription-based access. Analytics functions track user interactions, providing feedback to organizers on audience engagement and revenue outcomes.

FIG. 6B is an example interface 624 for tracking pre-sale engagement in accordance with the data flow of FIG. 6A. This interface 624 can enable members of the first user class to monitor real-time interest, early purchasing behavior, and related activity associated with upcoming events. As shown in the interface 624, each event can be listed with relevant identifiers including the event title, location, scheduled date, pricing information, and the number of tracks or media items associated with that entry. In some implementations, a central “Stock & Sales” column 626 can provide an at-a-glance view of pre-sale performance, displaying metrics such as total units allocated, units sold, and remaining availability. These indicators can provide organizers with the ability to evaluate user demand, identify trends across different events, and adjust distribution or promotional strategies accordingly. The interface 624 can also present status indicators 628, for example, such as DRAFT, BREWING, or SERVED, that reflect the event’s current readiness within the pre-sale and production lifecycle. In some implementations, administrators can access additional controls 630, including editing tools, gallery management, preview links, and track-management functions, enabling a streamlined workflow from pre-event preparation to eventual release. Through this unified interface 624, organizers can gain actionable insights into engagement levels before the event takes place, supporting data-driven decisions regarding inventory, marketing, and tokenized distribution strategies.

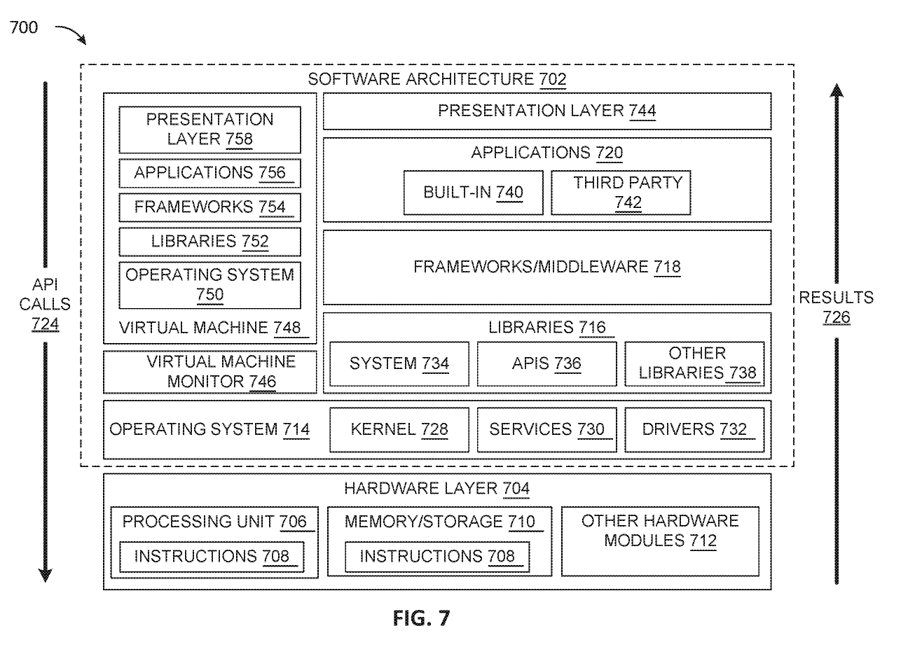

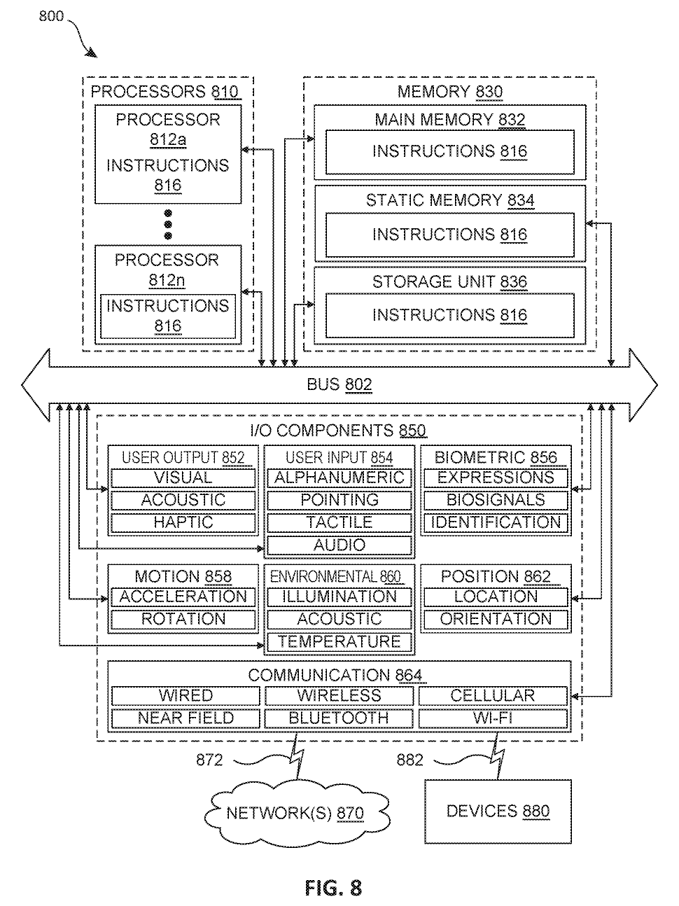

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory/storage, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks/middleware 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks/middleware 718 provide a higher-level common infrastructure that may be used by the applications 720 and/or other software modules. For example, the frameworks/middleware 718 may provide various graphic user interface (GUI) functions, high-level resource management, or high-level location services. The frameworks/middleware 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks/middleware 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory/storage 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multicore processor including cores that may execute instructions contemporaneously. Although FIG. 8 shows multiple processors, the machine 800 may include a single processor with a single core, a single processor with multiple cores (for example, a multicore processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system comprising:
a processor; and
a memory in communication with the processor, the memory comprising executable instructions that, when executed by the processor, cause the system to perform functions of:
creating an event-specific landing page, wherein the event-specific landing page is created by a member of a first user class;
limiting access to the event-specific landing page to a second user class;
receiving, via the event-specific landing page, event-specific media from members of the second user class, wherein the event-specific media comprises at least one of digital photographs of an event, audio recordings of the event, videos of the event, and combinations thereof;
obtaining a master media recording of the event, wherein the master media recording comprises at least one of audio recordings of the event, videos of the event, and combinations thereof; and
combining the event-specific media and master media recording into a resultant media, wherein the resultant media comprises at least one of a generated audio recording of the event, a generated video of the event, and combinations thereof.

2. The system of claim 1, wherein the event-specific landing page is configured to receive orders for the resultant media based on creation of the event-specific landing page.

3. The system of claim 1, wherein the event-specific landing page is configured to make the resultant media available for download based on combining the event-specific media and master media recording into a resultant media.

4. The system of claim 1, wherein combining the event-specific media and master media recording into a resultant media is performed by at least one module selected from the group consisting of a neural network, a vision-language model, and combinations thereof,
wherein the neural network is configured to:
encode the event-specific media and master media into a multimodal input tensor N,
align, via an attention based fusion layer, the multimodal input tensor N into a context-aligned latent tensor L; and
decode, via a generative decoder, L into a resultant media tensor R, wherein R comprises at least one of synchronized audio frames, synchronized visual frames, and combinations thereof;
and wherein the vision-language model is configured to:
encode the event-specific media and master media recording into a normalized prompt object P, wherein P comprises multimodal embeddings within a shared embedding space;
align, via a cross-attention alignment layer, the embeddings of P to generate a multimodal latent tensor V, wherein V encodes semantic embeddings including correlated semantic, spatial, and temporal relationships between the event-specific and master media to form encoded semantic embeddings; and
decode, via a multimodal generative decoder, V into a resultant media tensor R2, wherein R2 comprises synchronized audiovisual frames augmented by contextual metadata derived from the encoded semantic embeddings.

5. The system of claim 1, wherein receiving event-specific media from members of the second user class includes verification of a physical presence of each member of the second user class at the event, wherein the verification comprises utilizing at least one of login credentials, QR code tickets, QR code posters, wherein the QR code posters are limited to a physical location of the event, tokenized passes, and geofencing.

6. The system of claim 1, wherein combining the event-specific media and master media recording into a resultant media includes approving the resultant media by a member of the first user class.

7. The system of claim 1, further comprising:
receiving one or more distribution parameters from the first user class;
encoding the distribution parameters into a normalized prompt object D, wherein the distribution parameters comprise at least one vector selected from the group consisting of access-control vectors, geographic-limitation vectors, monetization-tier vectors, and temporal-availability vectors;
embedding the distribution parameters into a policy tensor comprising a policy tensor field that defines weighted relationships between user-class identifiers, access conditions, and resultant media metadata, wherein the policy tensor comprises policy tensor elements, and wherein each element of the policy tensor corresponds to a distribution constraint encoded as a multidimensional vector;
aligning the policy tensor field with an embedding RME of the resultant media tensor to generate a distribution-aware composite prompt CP, wherein CP encodes correlations between content features and policy vectors; and
tokenizing the resultant media based on the distribution parameters, wherein tokenization comprises generating one or more token objects each associated with a unique rights vector and a policy embedding derived from CP, such that each token object governs access, duplication, or transfer of the resultant media in accordance with the distribution parameters.

8. A method, comprising:
creating an event-specific landing page, wherein the event-specific landing page is created by a member of a first user class;
limiting access to the event-specific landing page to a second user class;
receiving, via the landing page, event-specific media from members of the second user class, wherein the event-specific media comprises at least one element selected from the group consisting of digital photographs of an event, audio recordings of the event, videos of the event, and combinations thereof;
obtaining a master media recording of the event, wherein the master media recording comprises at least one of audio recordings of the event, videos of the event, and combinations thereof; and
combining the event-specific media and master media recording into a resultant media, wherein the resultant media comprises at least one of a generated audio recording of the event, a generated video of the event, and combinations thereof.

9. The method of claim 8, wherein the event-specific landing page is configured to receive orders for the resultant media based on creation of the event-specific landing page.

10. The method of claim 8, wherein the event-specific landing page is configured to make the resultant media available for download based on combining the event-specific media and master media recording into a resultant media.

11. The method of claim 8, wherein combining the event-specific media and master media recording into a resultant media is performed by at least one module selected from the group consisting of a neural network, a vision-language model, and combinations thereof,
wherein the neural network is configured to:
encode the event-specific media and master media into a multimodal input tensor N,
align, via an attention based fusion layer, the multimodal input tensor N into a context-aligned latent tensor L; and
decode, via a generative decoder, L into a resultant media tensor R, wherein R comprises at least one of synchronized audio frames, synchronized visual frames, and combinations thereof;
and wherein the vision-language model is configured to:
encode the event-specific media and master media recording into a normalized prompt object P, wherein P comprises multimodal embeddings within a shared embedding space;
align, via a cross-attention alignment layer, the embeddings of P to generate a multimodal latent tensor V, wherein V encodes semantic embeddings including correlated semantic, spatial, and temporal relationships between the event-specific and master media to form encoded semantic embeddings; and
decode, via a multimodal generative decoder, V into a resultant media tensor R2, wherein R2 comprises synchronized audiovisual frames augmented by contextual metadata derived from the encoded semantic embeddings.

12. The method of claim 8, wherein receiving event-specific media from members of the second user class includes verification of a physical presence of each member of the second user class at the event wherein the verification comprises utilizing at least one of login credentials, QR code tickets, QR code posters, wherein the QR code posters are limited to a physical location of the event, tokenized passes, and geofencing.

13. The method of claim 8, wherein combining the event-specific media and master media recording into a resultant media includes approving the resultant media by a member of the first user class.

14. The method of claim 8, further comprising:
receive one or more distribution parameters from the first user class;
encoding the distribution parameters into a normalized prompt object D, wherein the distribution parameters comprise at least one vector selected from the group consisting of access-control vectors, geographic-limitation vectors, monetization-tier vectors, and temporal-availability vectors;
embedding the distribution parameters into a policy tensor comprising a policy tensor field that defines weighted relationships between user-class identifiers, access conditions, and resultant media metadata, wherein the policy tensor comprises policy tensor elements, and wherein each element of the policy tensor corresponds to a distribution constraint encoded as a multidimensional vector;
aligning the policy tensor field with an embedding RME of the resultant media tensor to generate a distribution-aware composite prompt CP, wherein CP encodes correlations between content features and policy vectors; and
tokenizing the resultant media based on the distribution parameters, wherein tokenization comprises generating one or more token objects each associated with a unique rights vector and a policy embedding derived from CP, such that each token object governs access, duplication, or transfer of the resultant media in accordance with the distribution parameters.

15. A non-transitory computer readable medium on which are stored instructions that when executed cause a programmable device to:
create an event-specific landing page, wherein the event-specific landing page is created by a member of a first user class;
limit access to the event-specific landing page to a second user class;
receive, via the landing page, event-specific media from members of the second user class, wherein the event-specific media comprises at least one of digital photographs of an event, audio recordings of the event, videos of the event, and combinations thereof;
obtain a master media recording of the event, wherein the master media recording comprises at least one of audio recordings of the event, videos of the event, and combinations thereof; and
combine the event-specific media and master media recording into a resultant media, wherein the resultant media comprises at least one of a generated audio recording of the event, a generated video of the event, and combinations thereof.

16. The non-transitory computer readable medium of claim 15, wherein the event-specific landing page is configured to receive orders for the resultant media based on creation of the event-specific landing page, and wherein the event-specific landing page is configured to make the resultant media available for download based on combining the event-specific media and master media recording into a resultant media.

17. The non-transitory computer readable medium of claim 15, wherein combining the event-specific media and master media recording into a resultant media is performed by at least one module selected from the group consisting of a neural network, a vision-language model, and combinations thereof,
wherein the neural network is configured to:
encode the event-specific media and master media into a multimodal input tensor N,
align, via an attention based fusion layer, the multimodal input tensor N into a context-aligned latent tensor L; and
decode, via a generative decoder, L into a resultant media tensor R, wherein R comprises at least one of synchronized audio frames, synchronized visual frames, and combinations thereof;
and wherein the vision-language model is configured to:
encode the event-specific media and master media recording into a normalized prompt object P, wherein P comprises multimodal embeddings within a shared embedding space;
align, via a cross-attention alignment layer, the embeddings of P to generate a multimodal latent tensor V, wherein V encodes semantic embeddings including correlated semantic, spatial, and temporal relationships between the event-specific and master media to form encoded semantic embeddings; and
decode, via a multimodal generative decoder, V into a resultant media tensor R2, wherein R2 comprises synchronized audiovisual frames augmented by contextual metadata derived from the encoded semantic embeddings.

18. The non-transitory computer readable medium of claim 15, wherein receiving event-specific media from members of the second user class includes verification of a physical presence of each member of the second user class at the event, wherein the verification comprises utilizing at least one of login credentials, QR code tickets, QR code posters, wherein the QR code posters are limited to a physical location of the event, tokenized passes, and geofencing.

19. The non-transitory computer readable medium of claim 15, wherein combining the event-specific media and master media recording into a resultant media includes approving the resultant media by a member of the first user class.

20. The non-transitory computer readable medium of claim 15, further comprising instructions that when executed cause a programmable device to: receive one or more distribution parameters from the first user class;
encode the distribution parameters into a normalized prompt object D, wherein the distribution parameters comprise at least one vector selected from the group consisting of access-control vectors, geographic-limitation vectors, monetization-tier vectors, and temporal-availability vectors;
embed the distribution parameters into a policy tensor comprising a policy tensor field that defines weighted relationships between user-class identifiers, access conditions, and resultant media metadata, wherein the policy tensor comprises policy tensor elements, and wherein each element of the policy tensor corresponds to a distribution constraint encoded as a multidimensional vector;
align the policy tensor field with an embedding RME of the resultant media tensor to generate a distribution-aware composite prompt CP, wherein CP encodes correlations between content features and policy vectors; and
tokenize the resultant media based on the distribution parameters, wherein tokenization comprises generating one or more token objects each associated with a unique rights vector and a policy embedding derived from CP, such that each token object governs access, duplication, or transfer of the resultant media in accordance with the distribution parameters.
